(19) United States
(12) Patent Application Publication
(10) Pub. No.: US 2026/0280411 A1
(43) Pub. Date: Sep. 17, 2026

(54) ELECTRONIC CIRCUITRY, POWER CONVERTER, AND DRIVING METHOD

(71) Applicant: Kabushiki Kaisha Toshiba, Kawasaki-shi (JP)

(72) Inventors: Yuto BUSHIMATA, Kawasaki Kanagawa (JP); Shusuke KAWAI, Fujisawa Kanagawa (JP); Hiroaki ISHIHARA, Yokohama Kanagawa (JP); Takeshi UENO, Kawasaki Kanagawa (JP); Kohei HORII, Kawasaki Kanagawa (JP); Koutaro MIYAZAKI, Taito Tokyo (JP)

(21) Appl. No.: 19/533,922

(22) Filed: Feb. 9, 2026

(30) Foreign Application Priority Data
Mar. 12, 2025 (JP) 2025-039635

(51) Int. Cl. H02M 1/084; H02M 1/00; H02M 7/5387

(52) U.S. Cl. CPC H02M 1/084; H02M 1/0009; H02M 1/0025; H02M 1/0058; H02M 7/53871

(57) ABSTRACT

An electronic circuitry includes a voltage detection circuit configured to detect an output voltage of a switching element controlled in accordance with a control signal instructing a turn-off operation or a turn-on operation; a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and a current supply circuit configured to supply a drive current to the switching element based on the first current value or the second current value determined by the controller.

### CROSS REFERENCE TO RELATED APPLICATIONS

This application is based upon and claims the benefit of priority from the prior Japanese Patent Application No. 2025-039635, filed on Mar. 12, 2025, the entire contents of which are incorporated herein by reference.

### FIELD

Embodiments described herein relate to an electronic circuitry, a power converter, and a driving method.

### BACKGROUND

A switching element used in a power circuit, an inverter, or the like exhibits a smaller power loss as a transition time in a turn-on operation or a turn-off operation is shorter. However, electromagnetic noise (electro-magnetic interference (EMI)) is generated in a turn-on operation or a turn-off operation of the switching element, and the magnitude of EMI is larger as the transition time is shorter. In other words, the power loss and EMI have a trade-off relation. In order to adjust such trade-off, it is considered to control the magnitude of drive current supplied during a transition period in a turn-on operation or a turn-off operation of the switching element.

The transition period in a turn-on operation or a turn-off operation of the switching element is shorter as the drive current is larger. On the other hand, the surge of output current or output voltage occurs in a turn-on operation or a turn-off operation of the switching element, and the magnitude of the occurring surge is larger as the drive current is larger.

### BRIEF DESCRIPTION OF THE DRAWINGS

FIG. 1 is a diagram illustrating the configuration of a half-bridge inverter according to Embodiment 1;

FIG. 2 is a diagram illustrating a detailed configuration of a drive circuit of Embodiment 1;

FIG. 3 is a diagram illustrating a detailed configuration of a turn-off current command circuit of Embodiment 1;

FIG. 4 is a diagram for description of an operation of a switching element of Embodiment 1 in a turn-off operation;

FIG. 5 is a diagram illustrating a detailed configuration of a turn-on current command circuit of Embodiment 1;

FIG. 6 is a diagram for description of an operation of the switching element of Embodiment 1 in a turn-on operation;

FIG. 7 is a diagram illustrating a detailed configuration of a turn-off current command circuit of Embodiment 2;

FIG. 8 is a diagram for description of an operation of a switching element of Embodiment 2 in a turn-off operation;

FIG. 9 is a diagram illustrating a detailed configuration of a turn-on current command circuit of Embodiment 2;

FIG. 10 is a diagram for description of an operation of the switching element of Embodiment 2 in a turn-on operation;

FIG. 11 is a diagram illustrating a detailed configuration of a turn-off current command circuit of Embodiment 3;

FIG. 12 is a diagram illustrating a detailed configuration of a turn-on current command circuit of Embodiment 3; and

FIG. 13 is a diagram illustrating the configuration of a three-phase inverter according to Embodiment 4.

### DETAILED DESCRIPTION

An electronic circuitry includes a voltage detection circuit configured to detect an output voltage of a switching element controlled in accordance with a control signal instructing a turn-off operation or a turn-on operation; a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and a current supply circuit configured to supply a drive current to the switching element based on the first current value or the second current value determined by the controller.

A power converter includes a half-bridge circuit including two switching elements; and a first drive circuit and a second drive circuit configured to control the two switching elements, respectively, in accordance with a control signal instructing a turn-off operation or a turn-on operation, wherein each of the first drive circuit and the second drive circuit includes: a voltage detection circuit configured to detect an output voltage of the switching element controlled by the drive circuit; a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and a current supply circuit configured to supply a drive current to the switching element based on the first current value or the second current value determined by the controller.

A driving method includes detecting an output voltage of a switching element controlled in accordance with a control signal instructing a turn-off operation or a turn-on operation; comparing, in a transition period of the turn-off operation or the turn-on operation, the output voltage with a first reference voltage determined in accordance with a power voltage, and determining, based on a comparison result, a first current value or a second current value having an absolute value smaller than an absolute value of the first current value and a direction same as a direction of the first current value; and supplying a drive current to the switching element based on the first current value or the second current value.

The present embodiments will be described below with reference to the accompanying drawings. In the drawings, identical or corresponding elements are denoted by the same reference signs, and detailed description thereof will not be repeated as appropriate.

### Embodiment 1

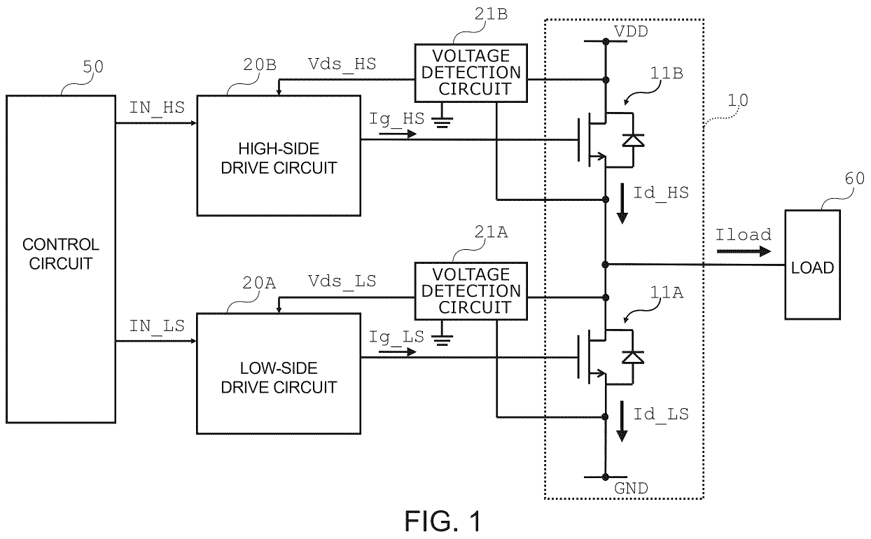

FIG. 1 is a diagram illustrating the configuration of a half-bridge inverter that is a power converter according to Embodiment 1. The half-bridge inverter includes a half-bridge circuit 10, a low-side drive circuit 20A, a high-side drive circuit 20B, voltage detection circuits 21A and 21B, and a control circuit 50. A load 60 is connected to an output of the half-bridge inverter. The low-side drive circuit 20A, the high-side drive circuit 20B, the voltage detection circuits 21A and 21B, and the control circuit 50 may be configured as electronic circuitry.

The half-bridge circuit 10 includes switching elements 11A and 11B, which are controlled to be driven in accordance with control signals supplied from the control circuit 50. For example, the switching elements 11A and 11B may be N-channel metal oxide semiconductor field effect transistors (MOSFETs). Alternatively, the switching elements 11A and 11B may be N-channel insulated gate bipolar transistors (IGBTs).

The drain of the low-side switching element 11A is connected to the source of the high-side switching element 11B. The source of the switching element 11A is connected to a ground GND of the half-bridge inverter. The drain of the high-side switching element 11B is connected to a power voltage VDD of the half-bridge inverter.

The voltage detection circuit 21A detects a drain-source voltage (low-side output voltage) Vds_LS of the low-side switching element 11A, and outputs a voltage equal to the detected voltage. The output from the voltage detection circuit 21A is input to the low-side drive circuit 20A. Similarly, the voltage detection circuit 21B detects a drain-source voltage (high-side output voltage) Vds_HS of the high-side switching element 11B, and outputs a voltage equal to the detected voltage. The output from the voltage detection circuit 21B is input to the high-side drive circuit 20B.

Instead of outputting a voltage equal to the drain-source voltage Vds of the corresponding switching element 11, the voltage detection circuits 21A and 21B may each output a voltage obtained by dividing the drain-source voltage Vds at a certain ratio by using a voltage divider circuit constituted by a capacitor or a resistor. In a case where the ground GND of the low-side switching element 11A and the ground of the voltage detection circuit 21A are common, input of source voltage to the voltage detection circuit 21A may be omitted.

The direction of a current (load current) Iload supplied from the half-bridge inverter to the load 60 is defined such that a direction in which the current flows from the half-bridge circuit 10 to the load 60 is positive, and a direction in which the current flows from the load 60 to the half-bridge circuit 10 is negative. However, this definition may be reversed.

The low-side drive circuit 20A supplies a gate current (low-side drive current) Ig_LS to the low-side switching element 11A in accordance with a low-side control signal IN_LS supplied from the control circuit 50. Specifically, when the low-side control signal IN_LS is “Hi” (for example, +5 V), the drive current Ig_LS flows from the drive circuit 20A toward the gate of the switching element 11A. In other words, the positive drive current Ig_LS is supplied from the drive circuit 20A to the switching element 11A. On the other hand, when the low-side control signal IN_LS is “Lo” (for example, 0 V), the drive current Ig_LS flows from the gate of the switching element 11A toward the drive circuit 20A. In other words, the negative drive current Ig_LS is supplied from the drive circuit 20A to the switching element 11A.

Similarly, the high-side drive circuit 20B supplies a gate current (high-side drive current) Ig_HS to the high-side switching element 11B in accordance with a high-side control signal IN_HS supplied from the control circuit 50. Specifically, when the high-side control signal IN_HS is “Hi” (for example, +5 V), the drive current Ig_HS flows from the drive circuit 20B toward the gate of the switching element 11B. In other words, the positive drive current Ig_HS is supplied from the drive circuit 20B to the switching element 11B. On the other hand, when the high-side control signal IN_HS is “Lo” (for example, 0 V), the drive current Ig_HS flows from the gate of the switching element 11B toward the drive circuit 20B. In other words, the negative drive current Ig_HS is supplied from the drive circuit 20B to the switching element 11B.

When the low-side switching element 11A is on, a drain current (output current) Id_LS of the switching element 11A flows in a direction from the drain of the switching element 11A to the source thereof. Similarly, when the high-side switching element 11B is on, a drain current (output current) Id_HS of the switching element 11B flows in a direction from the drain of the switching element 11B to the source thereof.

The control circuit 50 supplies the low-side control signal IN_LS to the low-side drive circuit 20A, and supplies the high-side control signal IN_HS to the high-side drive circuit 20B. The load 60 is any electronic apparatus or electric apparatus that is driven by alternating-current power. For example, in a case where the load 60 is an alternating-current motor, the control circuit 50 supplies the PWM-modulated low-side control signal IN_LS to the low-side drive circuit 20A, and supplies the PWM-modulated high-side control signal IN_HS to the high-side drive circuit 20B. Alternatively, the half-bridge inverter may be mounted in a power source apparatus such as a PV inverter for photovoltaic power generation. In this case, an output of the half-bridge circuit 10 is connected to a power grid in place of the load 60.

### Configuration of Drive Circuit

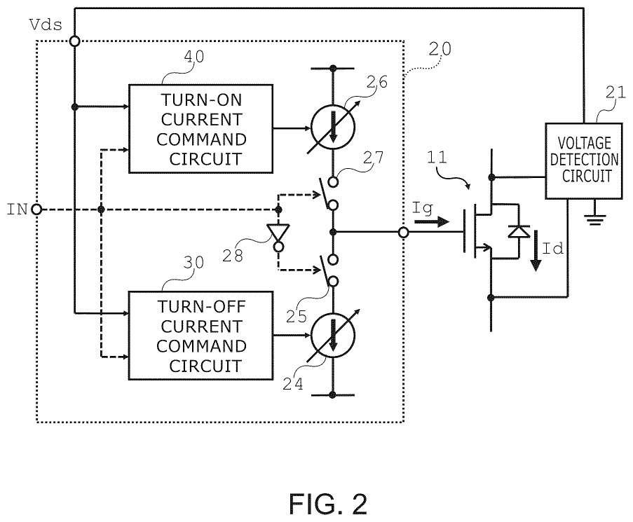

FIG. 2 is a diagram illustrating a detailed configuration of a drive circuit 20 according to Embodiment 1. Note that the low-side drive circuit 20A and the high-side drive circuit 20B have the same configuration, and thus hereinafter, are collectively referred to as the drive circuit 20 and described in a unified manner. This also applies to other constituent components. In addition, signals such as the control signals IN_LS and IN_HS are collectively referred to as a control signal IN or the like.

The drive circuit 20 includes a turn-off current command circuit 30, a turn-on current command circuit 40, a first variable current source 24, a first switch 25, a second variable current source 26, a second switch 27, and a NOT gate 28. The turn-off current command circuit 30 and the turn-on current command circuit 40 constitute a controller of the drive circuit 20. The constituent components 24 to 28 constitute a current supply circuit of the drive circuit 20.

The turn-off current command circuit 30 determines a command value of a drive current Ig_off to be supplied in a turn-off operation so that the surge of a drain current Id that occurs in a turn-off operation of the switching element 11 is suppressed. Specifically, the turn-off current command circuit 30 determines the command value of the drive current Ig_off based on the drain-source voltage Vds detected by the voltage detection circuit 21, and outputs the command value to the first variable current source 24. The first variable current source 24 outputs a current equal to the command value input from the turn-off current command circuit 30. The first switch 25 is turned on only when the control signal IN is “Lo”. Accordingly, in a turn-off operation of the switching element 11, the drive circuit 20 outputs the drive current Ig_off that is equal to the command value specified by the turn-off current command circuit 30.

Similarly, the turn-on current command circuit 40 determines a command value of a drive current Ig_on to be supplied in a turn-on operation so that the surge of the drain-source voltage Vds that occurs in a turn-on operation of the switching element 11 is suppressed. Specifically, the turn-on current command circuit 40 determines the command value of the drive current Ig_on based on the drain-source voltage Vds detected by the voltage detection circuit 21, and outputs the command value to the second variable current source 26. The second variable current source 26 outputs a current equal to the command value input from the turn-on current command circuit 40. The second switch 27 is turned on only when the control signal IN is “Hi”. Accordingly, in a turn-on operation of the switching element 11, the drive circuit 20 outputs the drive current Ig_on that is equal to the command value specified by the turn-on current command circuit 40.

### Configuration of Turn-Off Current Command Circuit

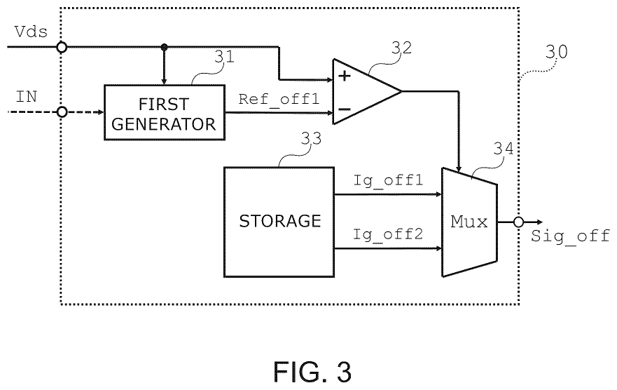

FIG. 3 is a diagram illustrating a detailed configuration of the turn-off current command circuit 30 according to Embodiment 1. The turn-off current command circuit 30 includes a first generator 31, a comparator (first timing detection circuit) 32, a memory (storage) 33, and a multiplexer 34.

Each time the switching element 11 is turned off, the first generator 31 generates a first reference voltage Ref_off1 to be used for control of the drive current Ig_off in the next turn-off operation of the switching element 11. Specifically, each time the switching element 11 is turned off, the first generator 31 generates the first reference voltage Ref_off1 in accordance with Expression (1) below based on a steady-state value Voff of the drain-source voltage Vds detected by the voltage detection circuit 21.

$$Ref\_off1 = α\_off \cdot V off \qquad ( 1 )$$

In Expression (1) above, the constant α_off is experimentally determined in advance so that the surge of the drain-source voltage Vds, which occurs in a turn-off operation, is always sufficiently suppressed within a variation range of the power voltage VDD of the half-bridge inverter. The constant α_off takes a value within a range greater than zero and less than one. For example, α_off is set to approximately 0.5.

In a turn-off transition period, the comparator 32 compares the drain-source voltage Vds of the switching element 11, which is detected by the voltage detection circuit 21, and the above-described first reference voltage Ref_off1, and outputs a logic value in accordance with the result of the comparison. Specifically, when the drain-source voltage Vds is higher than the first reference voltage Ref_off1, the logic output of the comparator 32 is “Hi”. On the other hand, when the drain-source voltage Vds is lower than the first reference voltage Ref_off1, the logic output of the comparator 32 is “Lo”. However, the correspondence between “Hi” and “Lo” may be reversed, and the logic output of the comparator 32 only needs to be inverted at a timing (first timing) when the drain-source voltage Vds of the switching element 11 crosses, and more precisely, exceeds the first reference voltage Ref_off1.

A current value Ig_off1 (first current value) and a current value Ig_off2 (second current value) that are experimentally determined in advance are stored in the memory 33. The current value Ig_off1 and the current value Ig_off2 take zero or negative values. The absolute value of the current value Ig_off2 is smaller than the absolute value of the current value Ig_off1, and the direction (sign) of the current value Ig_off2 is the same as the direction (sign) of the current value Ig_off1.

The multiplexer 34 selects and outputs any one of the current value Ig_off1 or the current value Ig_off2 stored in the memory 33 in accordance with the logic output of the comparator 32. Specifically, when the logic output of the comparator 32 is “Lo”, the multiplexer 34 selects and outputs the current value Ig_off1 stored in the memory 33. On the other hand, when the logic output of the comparator 32 is “Hi”, the multiplexer 34 selects and outputs the current value Ig_off2 stored in the memory 33. However, the correspondence between “Hi” and “Lo” may be reversed, and the output from the multiplexer 34 only needs to switch from the current value Ig_off1 to the current value Ig_off2 at the first timing when the drain-source voltage Vds of the switching element 11 exceeds the first reference voltage Ref_off1.

### Operation of Switching Element in Turn-Off Operation

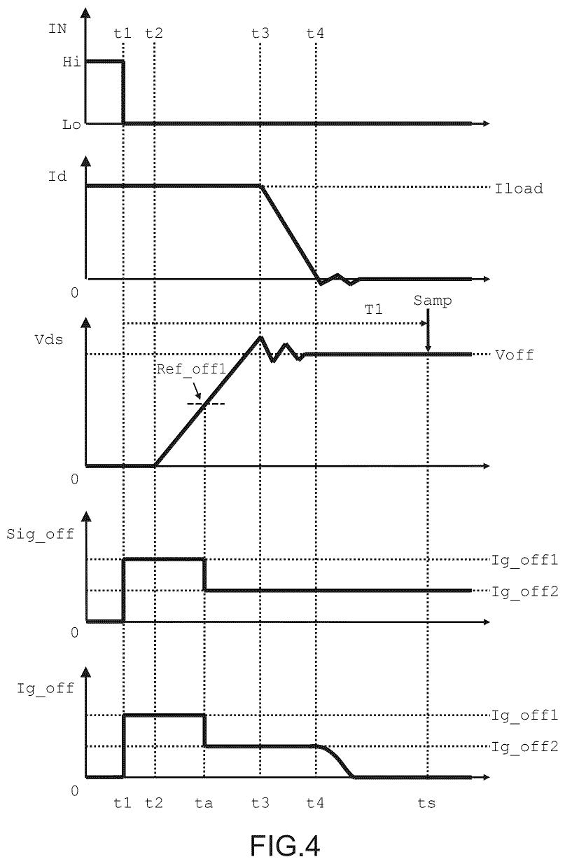

FIG. 4 is a diagram for description of an operation of the switching element 11 controlled by the drive circuit 20 according to Embodiment 1 in a turn-off operation. The uppermost time waveform is the time waveform of the control signal IN. The second time waveform is the time waveform of the drain current Id of the switching element 11. The third time waveform is the time waveform of the drain-source voltage Vds of the switching element 11. The fourth time waveform is the time waveform of a command value Sig_off output from the turn-off current command circuit 30. The fifth time waveform is the time waveform of the drive current Ig_off supplied from the drive circuit 20 to the switching element 11. However, the command value Sig_off and the drive current Ig_off are illustrated with their signs inverted.

At time point t1, when the control signal IN changes from “Hi” to “Lo”, the drive circuit 20 starts supply of the drive current Ig_off having the current value Ig_off1. Specifically, at start of a turn-off operation (t1), the drain-source voltage Vds of the switching element 11 is lower than the first reference voltage Ref_off1 generated by the first generator 31 in the previous turn-off operation. As a result, the logic output of the comparator 32 at start of a turn-off operation (t1) is “Lo”, and the multiplexer 34 outputs the current value Ig_off1. Consequently, the command value Sig_off output from the turn-off current command circuit 30 is the current value Ig_off1, and the first variable current source 24 outputs a current having the current value Ig_off1. Accordingly, when the control signal IN changes from “Hi” to “Lo” at time point t1 and the first switch 25 is turned on, the drive circuit 20 starts supply of the drive current Ig_off having the current value Ig_off1.

In order to shorten a turn-off delay time (t1 to t2 in FIG. 4) of the switching element 11, it is preferable that the absolute value of the current value Ig_off1 be as large as possible within a range in which operation of the switching element 11 becomes stable. A preferable current value Ig_off1 experimentally determined in advance is stored in the above-described memory 33.

At time point t2, the drain-source voltage Vds starts to increase. At time point ta, the drain-source voltage Vds exceeds the first reference voltage Ref_off1, and the first timing is detected. Specifically, when the drain-source voltage Vds exceeds the first reference voltage Ref_off1, the logic output of the comparator 32 inverts. Consequently, the output from the multiplexer 34 switches from the current value Ig_off1 to the current value Ig_off2. As a result, the command value Sig_off output from the turn-off current command circuit 30 switches from the current value Ig_off1 to the current value Ig_off2, and the first variable current source 24 outputs a current having the current value Ig_off2. Accordingly, when the first timing is detected at time point ta, the magnitude of the drive current Ig_off supplied from the drive circuit 20 switches from the current value Ig_off1 to the current value Ig_off2.

In order to suppress the surge of the drain-source voltage Vds, which occurs in a turn-off operation of the switching element 11, it is preferable that the absolute value of the current value Ig_off2 be as small as possible within the range in which operation of the switching element 11 becomes stable. However, when the current value Ig_off2 is excessively small, a turn-off time (t2 to t3 in FIG. 3) of the switching element 11 is long. The absolute value of the current value Ig_off2 is experimentally determined in advance to be a predetermined value smaller than the absolute value of the current value Ig_off1 in consideration of a trade-off therebetween.

At time point t3, the surge of the drain-source voltage Vds reaches a maximum value, and the drain current Id starts to decrease. At this time, at the first timing (ta) before time point t3, since the magnitude of the drive current Ig_off is switched from the current value Ig_off1 to the current value Ig_off2, the maximum value of voltage surge is significantly suppressed as compared to a case where the magnitude of the drive current Ig_off remains at the current value Ig_off1.

At time point t4, ringing of each of the drain current Id and the drain-source voltage Vds substantially converges, the drain current Id becomes zero, and a non-conduction state is established between the drain and the source. This completes turn-off of the switching element 11. At this time, for example, when the low-side switching element 11A is currently being focused on and a non-conduction state is established between the drain and the source thereof, a conduction state is established between the drain and the source of the high-side switching element 11B controlled as a pair therewith, and the power voltage VDD of the half-bridge inverter is all applied between the drain and the source of the low-side switching element 11A. Similarly, when the high-side switching element 11B is currently being focused on and a non-conduction state is established between the drain and the source thereof, a conduction state is established between the drain and the source of the low-side switching element 11A controlled as a pair therewith, and the power voltage VDD of the half-bridge inverter is all applied between the drain and the source of the high-side switching element 11B. In other words, regardless of whether the low-side switching element 11A or the high-side switching element 11B is currently being focused on, the drain-source voltage Vds of the switching element 11 after completion of a turn-off operation is equal to the power voltage VDD of the half-bridge inverter. Moreover, when the power voltage VDD varies due to change in the condition of the load 60 or the like and the actual power voltage VDD is different from a design value, the drain-source voltage Vds is equal to the actual power voltage VDD.

At time point t4 or later, the command value Sig_off output from the turn-off current command circuit 30 remains at Ig_off2, but the magnitude of the actual drive current Ig_off (<0) supplied from the drive circuit 20 to the switching element 11 decreases in a process in which electric charge accumulated at the gate of the switching element 11 is removed, and eventually becomes zero.

At time point ts, the first generator 31 samples the steady-state value Voff of the drain-source voltage Vds, and generates the first reference voltage Ref_off1 from the steady-state value Voff in accordance with Expression (1) described above. The first reference voltage Ref_off1 generated at this time is determined based on the current actual power voltage VDD, and is an appropriate value in accordance with variation of the power voltage VDD. The first reference voltage Ref_off1 generated in a turn-off operation in the n-th switching cycle is used for detection of the first timing (ta) in a turn-off operation in the next (n+1)-th switching cycle.

Time point ts only needs to be a time point at which the steady-state value Voff of the drain-source voltage Vds can be stably sampled. For example, time point ts may be a timing at which a first predetermined time (T1 in FIG. 3) has elapsed after timing (t1) at which the control signal IN changes from “Hi” to “Lo”. The first generator 31 may generate the first reference voltage Ref_off1 once a plurality of times or at a predetermined period, instead of generating the first reference voltage Ref_off1 in each turn-off operation. Including this case, in Embodiment 1, the first reference voltage Ref_off1 generated in a turn-off operation in the n-th switching cycle is used for detection of the first timing (ta) in a turn-off operation in the next (n+1)-th switching cycle or later.

In this manner, the drive current Ig_off in a turn-off operation of the switching element 11 is controlled so as to suppress the surge of the drain-source voltage Vds without being affected by variation of the power voltage VDD.

### Configuration of Turn-On Current Command Circuit

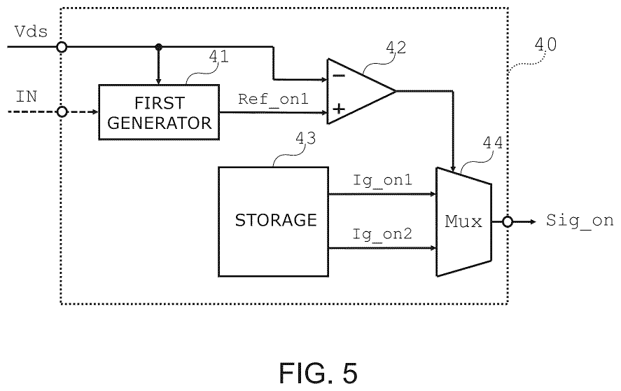

FIG. 5 is a diagram illustrating a detailed configuration of the turn-on current command circuit 40 according to Embodiment 1. The turn-on current command circuit 40 includes a first generator 41, a comparator (first timing detection circuit) 42, a memory (storage) 43, and a multiplexer 44.

Each time the switching element 11 is turned off, the first generator 41 generates a first reference voltage Ref_on1 to be used for control of the drive current Ig_on in a turn-on operation of the switching element 11 in the next switching cycle. Specifically, each time the switching element 11 is turned off, the first generator 41 generates the first reference voltage Ref_on1 in accordance with Expression (2) below based on the steady-state value Voff of the drain-source voltage Vds detected by the voltage detection circuit 21.

$$Ref\_on1 = α\_on \cdot V off \qquad ( 2 )$$

In Expression (2) above, the constant α_on is experimentally determined in advance so that the surge of the drain current Id, which occurs in a turn-on operation, is always sufficiently suppressed within the variation range of the power voltage VDD of the half-bridge inverter. The constant α_on takes a value within a range greater than zero and less than one. For example, α_on is set to approximately 0.9.

In a turn-on transition period, the comparator 42 compares the drain-source voltage Vds of the switching element 11, which is detected by the voltage detection circuit 21, and the above-described first reference voltage Ref_on1, and outputs a logic value in accordance with the result of the comparison. Specifically, when the drain-source voltage Vds is lower than the first reference voltage Ref_on1, the logic output of the comparator 42 is “Hi”. On the other hand, when the drain-source voltage Vds is higher than the first reference voltage Ref_on1, the logic output of the comparator 42 is “Lo”. However, the correspondence between “Hi” and “Lo” may be reversed, and the logic output of the comparator 42 only needs to be inverted at a timing (first timing) when the drain-source voltage Vds of the switching element 11 crosses, and more precisely, falls below the first reference voltage Ref_on1.

A current value Ig_on1 (first current value) and a current value Ig_on2 (second current value) that are experimentally determined in advance, are stored in the memory 43. The current value Ig_on1 and the current value Ig_on2 take zero or positive values. The absolute value of the current value Ig_on2 is smaller than the absolute value of the current value Ig_on1. The sign of the current value Ig_on2 is the same as the sign of the current value Ig_on1.

The multiplexer 44 selects and outputs any one of the current value Ig_on1 or the current value Ig_on2 stored in the memory 43 in accordance with the logic output of the comparator 42. Specifically, when the logic output of the comparator 42 is “Lo”, the multiplexer 44 selects and outputs the current value Ig_on1 stored in the memory 43. On the other hand, when the logic output of the comparator 42 is “Hi”, the multiplexer 44 selects and outputs the current value Ig_on2 stored in the memory 43. However, the correspondence between “Hi” and “Lo” may be reversed, and the output from the multiplexer 44 only needs to switch from the current value Ig_on1 to the current value Ig_on2 at the first timing when the drain-source voltage Vds of the switching element 11 falls below the first reference voltage Ref_on1.

### Operation of Switching Element in Turn-On Operation

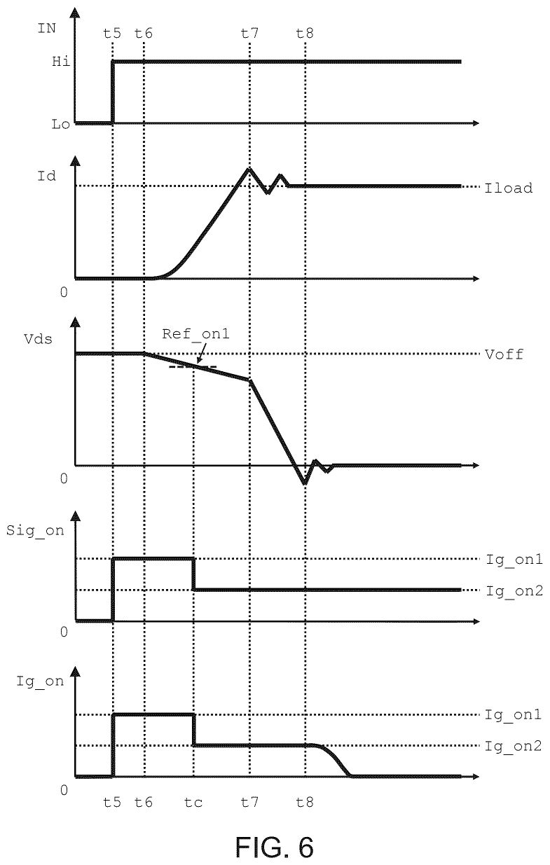

FIG. 6 is a diagram for description of an operation of the switching element 11 controlled by the drive circuit 20 according to Embodiment 1 in a turn-on operation. The uppermost time waveform is the time waveform of the control signal IN. The second time waveform is the time waveform of the drain current Id of the switching element 11. The third time waveform is the time waveform of the drain-source voltage Vds of the switching element 11. The fourth time waveform is the time waveform of a command value Sig_on output from the turn-on current command circuit 40. The fifth time waveform is the time waveform of the drive current Ig_on supplied from the drive circuit 20 to the switching element 11.

At time point t5, when the control signal IN changes from “Lo” to “Hi”, the drive circuit 20 starts supply of the drive current Ig_on having the current value Ig_on1. Specifically, at start of a turn-on operation (t5), the drain-source voltage Vds of the switching element 11 is higher than the first reference voltage Ref_on1 generated by the first generator 41 in the previous turn-off operation. As a result, the logic output of the comparator 42 at start of a turn-on operation (t5) is “Lo”, and the multiplexer 44 outputs the current value Ig_on1. Consequently, the command value Sig_on output from the turn-on current command circuit 40 is the current value Ig_on1, and the second variable current source 26 outputs a current having the current value Ig_on1. Accordingly, when the control signal IN changes from “Lo” to “Hi” at time point t5 and the second switch 27 is turned on, the drive circuit 20 starts supply of the drive current Ig_on having the current value Ig_on1.

In order to shorten a turn-on delay time (t5 to t6 in FIG. 6) of the switching element 11, it is preferable that the absolute value of the current value Ig_on1 be as large as possible within the range in which operation of the switching element 11 becomes stable. A preferable current value Ig_on1 experimentally determined in advance is stored in the above-described memory 43.

At time point t6, the drain current Id starts to flow and the drain-source voltage Vds starts to slightly decrease. At time point tc, the drain-source voltage Vds falls below the first reference voltage Ref_on1, and the first timing is detected. Specifically, when the drain-source voltage Vds falls below the first reference voltage Ref_on1, the logic output of the comparator 42 inverts. Consequently, the output from the multiplexer 44 switches from the current value Ig_on1 to the current value Ig_on2. As a result, the command value Sig_on output from the turn-on current command circuit 40 switches from the current value Ig_on1 to the current value Ig_on2, and the first variable current source 24 outputs a current having the current value Ig_on2. Accordingly, when the first timing is detected at time point tc, the magnitude of the drive current Ig_on supplied from the drive circuit 20 switches from the current value Ig_on1 to the current value Ig_on2.

In order to suppress the surge of the drain current Id, which occurs in a turn-on operation of the switching element 11, it is preferable that the absolute value of the current value Ig_on2 be as small as possible within the range in which operation of the switching element 11 becomes stable. However, when the current value Ig_on2 is excessively small, a turn-on time (t6 to t7 in FIG. 5) of the switching element 11 is long. The absolute value of the current value Ig_on2 is experimentally determined in advance to be a predetermined value smaller than the absolute value of the current value Ig_on1 in consideration of a trade-off therebetween.

At time point t7, the surge of the drain current Id reaches a maximum value, and the drain-source voltage Vds substantially starts to decrease. At this time, at the first timing (tc) before time point t7, since the magnitude of the drive current Ig_on is switched from the current value Ig_on1 to the current value Ig_on2, the maximum value of current surge is significantly suppressed as compared to a case where the magnitude of the drive current Ig_on remains at the current value Ig_on1.

At time point t8 or later, the command value Sig_on output from the turn-on current command circuit 40 remains at Ig_on2, but the magnitude of the actual drive current Ig_on supplied from the drive circuit 20 to the switching element 11 decreases in a process in which electric charge is accumulated at the gate of the switching element 11, and eventually becomes zero.

Although not illustrated in FIG. 6, in the next “turn-off operation” of the switching element 11, the first generator 41 samples the steady-state value Voff of the drain-source voltage Vds, and generates the first reference voltage Ref_on1 from the steady-state value Voff in accordance with Expression (2) described above. The first reference voltage Ref_on1 generated at this time is determined based on the current actual power voltage VDD, and is an appropriate value in accordance with variation of the power voltage VDD. The first reference voltage Ref_on1 generated in a turn-off operation in the n-th switching cycle is used for detection of the first timing (tc) in a turn-on operation in the next (n+1)-th switching cycle.

The first generator 41 may generate the first reference voltage Ref_on1 once a plurality of times or at a predetermined period, instead of generating the first reference voltage Ref_on1 in each turn-off operation. Including this case, in Embodiment 1, the first reference voltage Ref_on1 generated in a turn-off operation in the n-th switching cycle is used for detection of the first timing (tc) in a turn-on operation in the next (n+1)-th switching cycle or later.

In this manner, the drive current Ig_on in a turn-on operation of the switching element 11 is controlled so as to suppress the surge of the drain current Id without being affected by variation of the power voltage VDD.

As described above, the drive circuit 20 according to Embodiment 1 detects the first timing at which the output voltage Vds of the switching element 11 crosses the first reference voltage determined in accordance with the power voltage VDD, and at the first timing, switches the magnitude of the drive current Ig to a current value having an absolute value smaller than that of a current value before the first timing. Accordingly, the surge of the output voltage Vds and the output current Id, which occurs in a turn-off operation or a turn-on operation of the switching element 11, can be suppressed without being affected by variation of the power voltage VDD.

### Embodiment 2

A drive circuit of Embodiment 2 includes a turn-off current command circuit 230 and a turn-on current command circuit 240 in place of the turn-off current command circuit 30 and the turn-on current command circuit 40 of Embodiment 1. In Embodiment 2, a function is added that reduces power loss during switching by reducing the drive current at the first timing to suppress surge and then increasing the drive current again to shorten a switching transition time.

### Configuration of Turn-Off Current Command Circuit

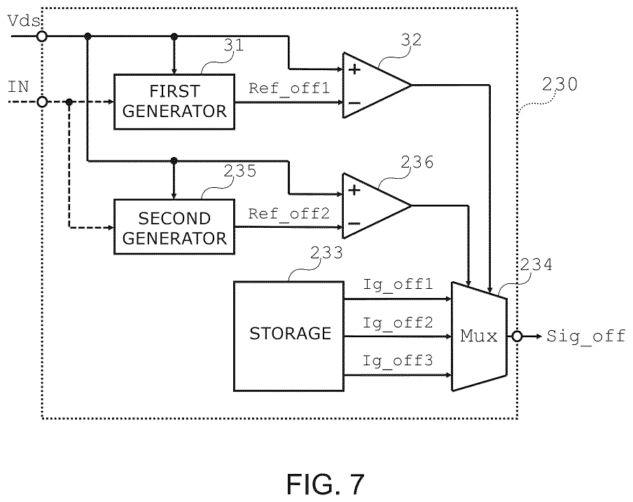

FIG. 7 is a diagram illustrating a detailed configuration of the turn-off current command circuit 230 according to Embodiment 2. The turn-off current command circuit 230 includes the first generator 31, the comparator (first timing detection circuit) 32, a second generator 235, a comparator (second timing detection circuit) 236, a memory 233, and a multiplexer 234. The configurations and operations of the first generator 31 and the comparator 32 are the same as in Embodiment 1.

Each time the switching element 11 is turned off, the second generator 235 generates a second reference voltage Ref_off2 to be used for control of the drive current Ig_off in the next turn-off operation of the switching element 11. Specifically, each time the switching element 11 is turned off, the second generator 235 generates the second reference voltage Ref_off2 in accordance with Expression (3) below based on the steady-state value Voff of the drain-source voltage Vds detected by the voltage detection circuit 21.

$$Ref\_off2 = β\_off \cdot V off \qquad ( 3 )$$

In Expression (3) above, the constant β_off is experimentally determined in advance so that various conditions to be described later are satisfied within the variation range of the power voltage VDD of the half-bridge inverter. The constant β_off takes a value greater than zero and may take a value greater than one. For example, β_off is set to approximately 0.9.

The comparator 236 compares the drain-source voltage Vds of the switching element 11, which is detected by the voltage detection circuit 21, and the above-described second reference voltage Ref_off2, and outputs a logic value in accordance with the result of the comparison. Specifically, when the drain-source voltage Vds is higher than the second reference voltage Ref_off2, the logic output of the comparator 236 is “Hi”. On the other hand, when the drain-source voltage Vds is lower than the second reference voltage Ref_off2, the logic output of the comparator 236 is “Lo”. However, the correspondence between “Hi” and “Lo” may be reversed, and the logic output of the comparator 236 only needs to be inverted at a timing (second timing) when the drain-source voltage Vds of the switching element 11 crosses, and more precisely, exceeds the second reference voltage Ref_off2.

Current values Ig_off1 to Ig_off3 experimentally determined in advance are stored in the memory 233. The current value Ig_off1 and the current value Ig_off2 are the same as in Embodiment 1. The current value Ig_off3 (third current value) takes zero or a negative value. The absolute value of the current value Ig_off3 is larger than the absolute value of the current value Ig_off2.

The multiplexer 234 selects and outputs any one of the current values Ig_off1 to Ig_off3 stored in the memory 233 in accordance with the logic outputs of the comparators 32 and 236. Specifically, when the logic outputs of the comparators 32 and 236 are both “Lo”, the multiplexer 234 selects and outputs the current value Ig_off1 stored in the memory 233. When the logic output of the comparator 32 is “Hi” and the logic output of the comparator 236 is “Lo”, the multiplexer 234 selects and outputs the current value Ig_off2 stored in the memory 233. When the logic outputs of the comparators 32 and 236 are both “Hi”, the multiplexer 234 selects and outputs the current value Ig_off3 stored in the memory 233.

However, the correspondence between “Hi” and “Lo” is not limited thereto. The output from the multiplexer 234 only needs to switch from the current value Ig_off1 to the current value Ig_off2 at the first timing when the drain-source voltage Vds of the switching element 11 exceeds the first reference voltage Ref_off1, and the output from the multiplexer 234 only needs to switch from the current value Ig_off2 to the current value Ig_off3 at the second timing when the drain-source voltage Vds exceeds the second reference voltage Ref_off2.

### Operation of Switching Element in Turn-Off Operation

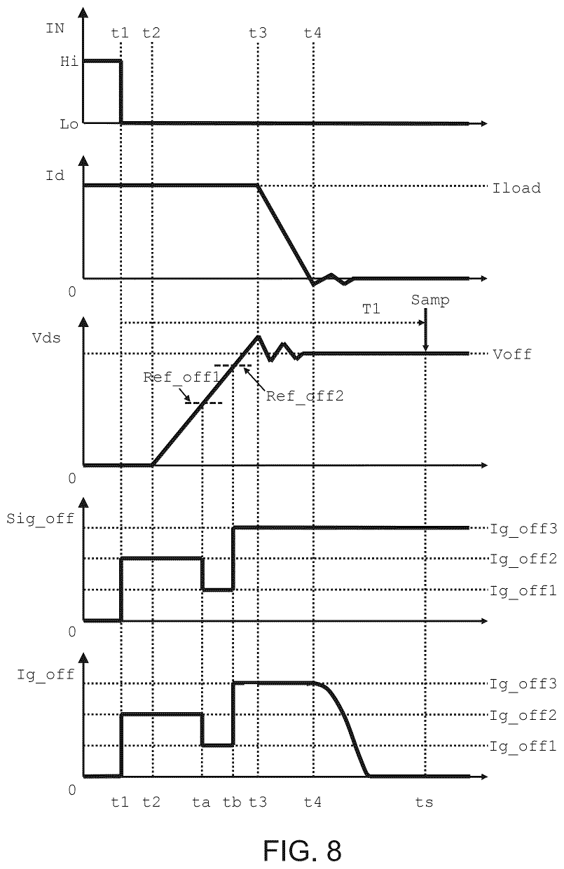

FIG. 8 is a diagram for description of an operation of the switching element 11 controlled by the drive circuit according to Embodiment 2 in a turn-off operation. The uppermost time waveform is the time waveform of the control signal IN. The second time waveform is the time waveform of the drain current Id of the switching element 11. The third time waveform is the time waveform of the drain-source voltage Vds of the switching element 11. The fourth time waveform is the time waveform of the command value Sig_off output from the turn-off current command circuit 230. The fifth time waveform is the time waveform of the drive current Ig_off supplied from the drive circuit to the switching element 11. However, the command value Sig_off and the drive current Ig_off are illustrated with their signs inverted.

The operation from time point t1 to time point ta is the same in Embodiment 1. At time point tb, the drain-source voltage Vds exceeds the second reference voltage Ref_off2, and the second timing is detected. Specifically, when the drain-source voltage Vds exceeds the second reference voltage Ref_off2, the logic output of the comparator 236 inverts. Consequently, the output from the multiplexer 234 switches from the current value Ig_off2 to the current value Ig_off3. As a result, the command value Sig_off output from the turn-off current command circuit 230 switches from the current value Ig_off2 to the current value Ig_off3, and the first variable current source 24 outputs a current having the current value Ig_off3. Accordingly, when the second timing is detected at time point tb, the magnitude of the drive current Ig_off supplied from the drive circuit switches from the current value Ig_off2 to the current value Ig_off3. The operation from time point t3 to time point t4 is the same as in Embodiment 1.

In order to reduce power loss in a turn-off operation of the switching element 11, it is preferable that the absolute value of the current value Ig_off3 be as large as possible within an allowable range of EMI. In addition, in order to prevent unintended conduction of the switching element 11 after completion of a turn-off operation, it is preferable that the absolute value of the current value Ig_off3 be as large as possible within the range in which operation of the switching element 11 becomes stable. In consideration of these conditions, for example, the current value Ig_off3 may be a maximum current value in a negative direction (direction from the switching element 11 to the drive circuit) in which the first variable current source 24 can output.

In this manner, the drive current Ig_off in a turn-off operation of the switching element 11 is controlled so that the surge of the drain-source voltage Vds is suppressed and power loss in a turn-off operation is reduced without being affected by variation of the power voltage VDD.

### Configuration of Turn-On Current Command Circuit

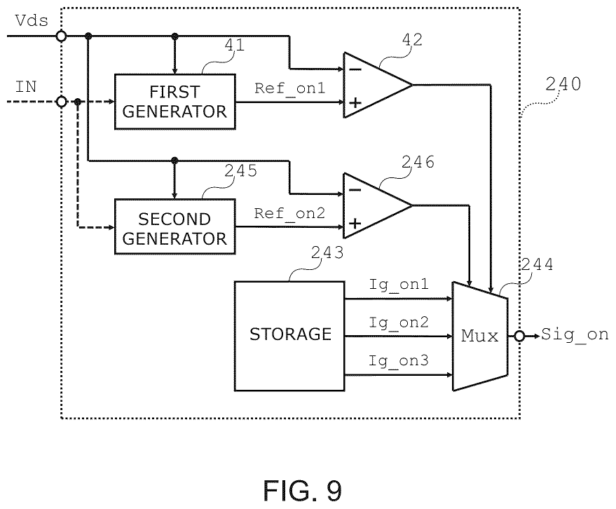

FIG. 9 is a diagram illustrating a detailed configuration of the turn-on current command circuit 240 according to Embodiment 2. The turn-on current command circuit 240 includes the first generator 41, the comparator (first timing detection circuit) 42, a second generator 245, a comparator (second timing detection circuit) 246, a memory (storage) 243, and a multiplexer 244. The configurations and operations of the first generator 41 and the comparator 42 are the same as in Embodiment 1.

Each time the switching element 11 is “turned off”, the second generator 245 generates a second reference voltage Ref_on2 to be used for control of the drive current Ig_on in a turn-on operation of the switching element 11 in the next switching cycle. Specifically, each time the switching element 11 is turned off, the second generator 245 generates the second reference voltage Ref_on2 in accordance with Expression (4) below based on the steady-state value Voff of the drain-source voltage Vds detected by the voltage detection circuit 21.

$$Ref\_on2 = β\_on \cdot V off \qquad ( 4 )$$

In Expression (4) above, the constant β_on is experimentally determined in advance so that various conditions to be described later are satisfied within the variation range of the power voltage VDD of the half-bridge inverter. The constant β_on takes a value less than one and may take a negative value less than zero. For example, β_on is set to approximately 0.8.

The comparator 246 compares the drain-source voltage Vds of the switching element 11, which is detected by the voltage detection circuit 21, and the above-described second reference voltage Ref_on2, and outputs a logic value in accordance with the result of the comparison. Specifically, when the drain-source voltage Vds is lower than the second reference voltage Ref_on2, the logic output of the comparator 246 is “Hi”. On the other hand, when the drain-source voltage Vds is higher than the second reference voltage Ref_on2, the logic output of the comparator 246 is “Lo”. However, the correspondence between “Hi” and “Lo” may be reversed, and the logic output of the comparator 246 only needs to be inverted at a timing (second timing) when the drain-source voltage Vds of the switching element 11 crosses, and more precisely, falls below the second reference voltage Ref_on2.

Current values Ig_on1 to Ig_on3 experimentally determined in advance are stored in the memory 243. The current value Ig_on1 and the current value Ig_on2 are the same as in Embodiment 1. The current value Ig_on3 (third current value) takes zero or a positive value. The absolute value of the current value Ig_on3 is larger than the absolute value of the current value Ig_on2.

The multiplexer 244 selects and outputs any one of the current values Ig_on1 to Ig_on3 stored in the memory 243 in accordance with the logic outputs of the comparators 42 and 246. Specifically, when the logic outputs of the comparators 42 and 246 are both “Lo”, the multiplexer 244 selects and outputs the current value Ig_on1 stored in the memory 243. When the logic output of the comparator 42 is “Hi” and the logic output of the comparator 246 is “Lo”, the multiplexer 244 selects and outputs the current value Ig_on2 stored in the memory 243. When the logic outputs of the comparators 42 and 246 are both “Hi”, the multiplexer 244 selects and outputs the current value Ig_on3 stored in the memory 243.

However, the correspondence between “Hi” and “Lo” is not limited thereto. The output from the multiplexer 244 only needs to switch from the current value Ig_on1 to the current value Ig_on2 at the first timing when the drain-source voltage Vds of the switching element 11 falls below the first reference voltage Ref_on1, and the output from the multiplexer 244 only needs to switch from the current value Ig_on2 to the current value Ig_on3 at the second timing when the drain-source voltage Vds falls below the second reference voltage Ref_on2.

### Operation of Switching Element in Turn-On Operation

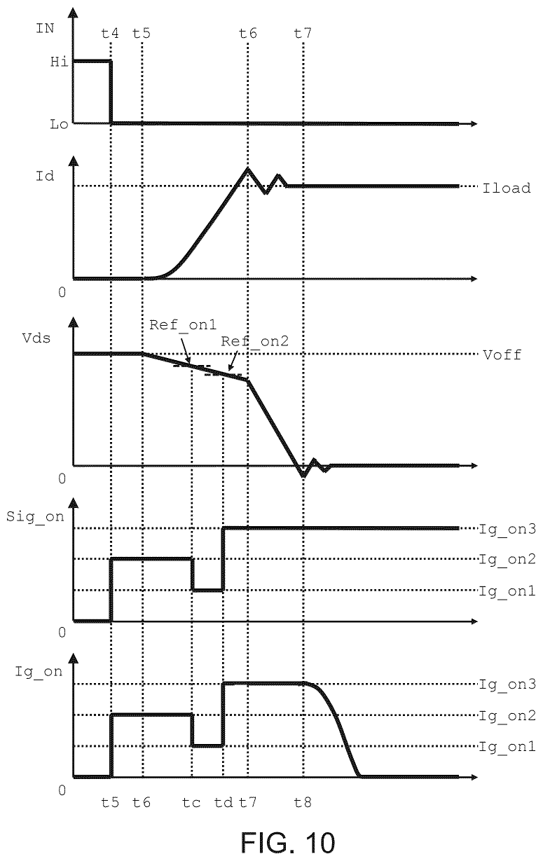

FIG. 10 is a diagram for description of an operation of the switching element 11 controlled by the drive circuit according to Embodiment 2 in a turn-on operation. The uppermost time waveform is the time waveform of the control signal IN. The second time waveform is the time waveform of the drain current Id of the switching element 11. The third time waveform is the time waveform of the drain-source voltage Vds of the switching element 11. The fourth time waveform is the time waveform of the command value Sig_on output from the turn-on current command circuit 240. The fifth time waveform is the time waveform of the drive current Ig_on supplied from the drive circuit to the switching element 11.

The operation from time point t5 to time point tc is the same as in Embodiment 1. At time point td, the drain-source voltage Vds falls below the second reference voltage Ref_on2, and the second timing is detected. Specifically, when the drain-source voltage Vds falls below the second reference voltage Ref_on2, the logic output of the comparator 246 inverts. Consequently, the output from the multiplexer 244 switches from the current value Ig_on2 to the current value Ig_on3. As a result, the command value Sig_on output from the turn-on current command circuit 240 switches from the current value Ig_on2 to the current value Ig_on3, and the second variable current source 26 outputs a current having the current value Ig_on3. Accordingly, when the second timing is detected at time point td, the magnitude of the drive current Ig_on supplied from the drive circuit switches from the current value Ig_on2 to the current value Ig_on3. The operation from time point t7 to time point t8 is the same as in Embodiment 1.

In order to reduce power loss in a turn-on operation of the switching element 11, it is preferable that the absolute value of the current value Ig_on3 be as large as possible within an allowable range of EMI. In addition, in order to prevent unintended conduction of the switching element 11 after completion of a turn-on operation, it is preferable that the absolute value of the current value Ig_on3 be as large as possible within the range in which operation of the switching element 11 becomes stable. In consideration of these conditions, for example, the current value Ig_on3 may be a maximum current value in a positive direction (direction from the drive circuit to the switching element 11) in which the second variable current source 26 can output.

In this manner, the drive current Ig_on in a turn-on operation of the switching element 11 is controlled so that the surge of the drain current Id is suppressed and power loss in a turn-on operation is reduced without being affected by variation of the power voltage VDD.

As described above, the drive circuit according to Embodiment 2 detects the second timing at which the output voltage Vds of the switching element 11 crosses the second reference voltage determined in accordance with the power voltage VDD, and switches the magnitude of the drive current Ig to a current value having an absolute value larger than that of a current value before the second timing. Accordingly, an unintended malfunction of the switching element after completion of a turn-off operation or completion of a turn-on operation is prevented without being affected by variation of the power voltage VDD.

Note that, in Embodiment 2 described above, instead of being detected based on the drain-source voltage Vds, the second timing may be detected as a timing at which a second predetermined time experimentally determined in advance with reference to the first timing has elapsed.

### Embodiment 3

In Embodiment 2 described above, the first reference voltage and the second reference voltage are generated based on the drain-source voltage Vds of the switching element 11, which is detected by the voltage detection circuit 21. In Embodiment 3, instead, the first reference voltage and the second reference voltage are generated based on information provided from the outside of the half-bridge inverter. For example, in a case where a microcomputer that controls the power voltage VDD of the half-bridge inverter is provided, information (for example, measurement value of the power voltage VDD) that depends on the power voltage VDD can be acquired from the microcomputer. The microcomputer may measure, as the power voltage VDD, a power voltage supplied thereto.

### Configuration of Turn-Off Current Command Circuit

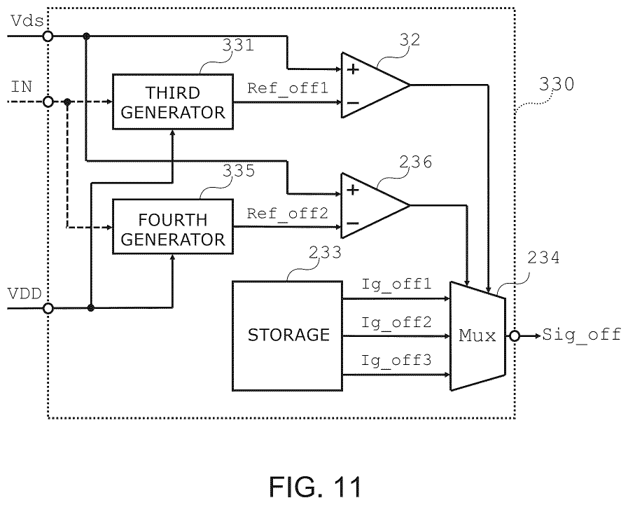

FIG. 11 is a diagram illustrating a detailed configuration of a turn-off current command circuit 330 according to Embodiment 3. The turn-off current command circuit 330 includes a third generator 331, the comparator (first timing detection circuit) 32, a fourth generator 335, the comparator (second timing detection circuit) 236, a memory (storage) 233, and the multiplexer 234. The configurations and operations of the comparators 32 and 236, the memory 233, and the multiplexer 234 are the same as in Embodiment 2.

At start of a turn-off operation of the switching element 11, the third generator 331 acquires the current actual power voltage VDD from a microcomputer that controls the power voltage of the half-bridge inverter, and the third generator 331 generates the first reference voltage Ref_off1 in a turn-off operation in accordance with Expression (5) below.

$$Ref\_off1 = α\_off \cdot V DD \qquad ( 5 )$$

In Expression (5) above, the constant α_off is the same as in Expression (1).

At start of a turn-off operation of the switching element 11, the fourth generator 335 acquires the current actual power voltage VDD from the microcomputer that controls the power voltage of the half-bridge inverter, and the fourth generator 335 generates the second reference voltage Ref_off2 in a turn-off operation in accordance with Expression (6) below.

$$Ref\_off2 = β\_off \cdot V DD \qquad ( 6 )$$

In Expression (6) above, the constant β_off is the same as in Expression (3).

### Operation of Switching Element in Turn-Off Operation

The operation of the switching element 11 controlled by a drive circuit according to Embodiment 3 in a turn-off operation is the same as that in Embodiment 2 except that it is not needed to sample the steady-state value of the drain-source voltage Vds after completion of a turn-off operation.

### Configuration of Turn-On Current Command Circuit

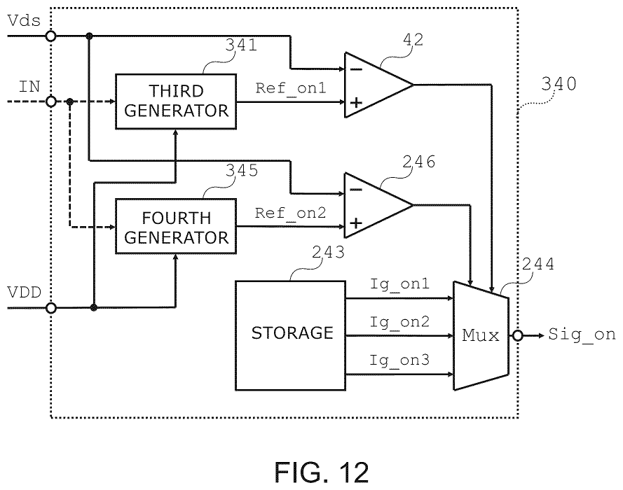

FIG. 12 is a diagram illustrating a detailed configuration of a turn-on current command circuit 340 according to Embodiment 3. The turn-on current command circuit 340 includes a third generator 341, the comparator (first timing detection circuit) 42, a fourth generator 345, the comparator (second timing detection circuit) 246, the memory 243, and the multiplexer 244. The configurations and operations of the comparators 42 and 246, the memory 243, and the multiplexer 244 are the same as in Embodiment 2.

At start of a turn-on operation of the switching element 11, the third generator 341 acquires the current actual power voltage VDD from the microcomputer that controls the power voltage of the half-bridge inverter, and the third generator 341 generates the first reference voltage Ref_on1 in a turn-on operation in accordance with Expression (7) below.

$$Ref\_on1 = α\_on \cdot V DD \qquad ( 7 )$$

In Expression (7) above, the constant α_on is the same as in Expression (2).

At start of a turn-on operation of the switching element 11, the fourth generator 345 acquires the current actual power voltage VDD from the microcomputer that controls the power voltage of the half-bridge inverter, and the fourth generator 345 generates the second reference voltage Ref_on2 in a turn-on operation in accordance with Expression (8) below.

$$Ref\_on2 = β\_on \cdot V DD \qquad ( 8 )$$

In Expression (8) above, the constant β_on is the same as in Expression (4).

### Operation of Switching Element in Turn-On Operation

The operation of the switching element 11 controlled by the drive circuit according to Embodiment 3 in a turn-off operation is the same as that in Embodiment 2 except that it is not needed to sample the steady-state value of the drain-source voltage Vds after completion of a turn-off operation.

As described above, the drive circuit according to Embodiment 3 generates the first reference voltage and the second reference voltage based on information provided from the outside of the half-bridge inverter. This eliminates the need to implement a function of sampling the steady-state value of the drain-source voltage Vds after completion of a turn-off operation in the first to fourth generators, thereby reducing the scale and cost of the drive circuit.

### Embodiment 4

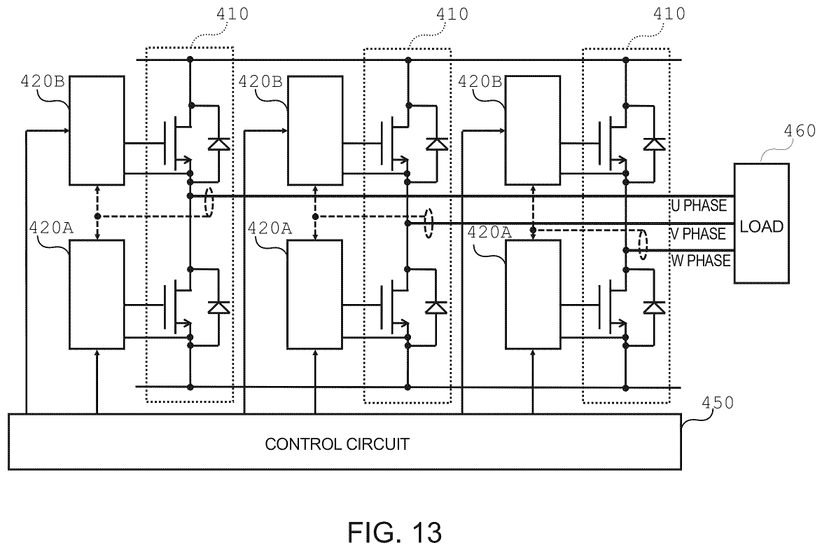

FIG. 13 is a diagram illustrating the configuration of a three-phase inverter that is a power conversion apparatus according to Embodiment 3. The three-phase inverter includes three half-bridge circuits 410, three low-side drive circuits 420A, three high-side drive circuits 420B, and a control circuit 450. A load 460 is connected to an output of the three-phase inverter. Each half-bridge circuit 410 has the same configuration as the half-bridge circuit in Embodiment 1 to 3. Each low-side drive circuit 420A has the same configuration as the low-side drive circuit in Embodiment 1 to 3. Each high-side drive circuit 420B has the same configuration as the high-side drive circuit in Embodiment 1 to 3.

The control circuit 450 supplies a low-side control signal to each low-side drive circuit 420A, and supplies a high-side control signal to each high-side drive circuit 420B. The load 460 is any electronic apparatus or electric apparatus that is driven by three-phase alternating-current power. For example, in a case where the load 460 is a three-phase alternating-current motor, the control circuit 450 supplies the PWM-modulated low-side control signal to each low-side drive circuit 420A, and supplies the PWM-modulated high-side control signal to each high-side drive circuit 420B.

As another application example, an inverter including a low-side drive circuit, a high-side drive circuit, a half-bridge circuit, and a control circuit may be used as a PV inverter for photovoltaic power generation. In this case, an output of the PV inverter is connected to a power grid.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### Clauses

Clause 1. An electronic circuitry comprising:
a voltage detection circuit configured to detect an output voltage of a switching element controlled in accordance with a control signal instructing a turn-off operation or a turn-on operation;
a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and
a current supply circuit configured to supply a drive current to the switching element based on the first current value or the second current value determined by the controller.

Clause 2 (which corresponds to embodiment 1). The electronic circuitry according to claim 1, wherein the controller is configured to determine the first current value before the output voltage reaches the first reference voltage, and determine the second current value after the output voltage reaches the first reference voltage.

Clause 3 (which corresponds to embodiment 1). The electronic circuitry according to claim 1 or 2, wherein the controller is configured to generate the first reference voltage based on a steady-state value of the output voltage after completion of the turn-off operation of the switching element.

Clause 4 (which corresponds to embodiment 1). The electronic circuitry according to claim 3, wherein the controller is configured to determine the first reference voltage Ref1 in accordance with the following expression: Ref1=α·Voff where Voff is the steady-state value of the output voltage, and α is a predetermined constant greater than 0 and less than 1.

Clause 5 (which corresponds to embodiment 1). The electronic circuitry according to claim 3 or 4, wherein the controller is configured to sample the steady-state value of the output voltage after completion of the turn-off operation of the switching element, and generate the first reference voltage based on the sampled steady-state value of the output voltage.

Clause 6 (which corresponds to embodiment 1). The electronic circuitry according to claim 5, wherein the controller is configured to sample the steady-state value of the output voltage at a timing when a first predetermined time has elapsed after a logic value of the control signal is inverted.

Clause 7 (which corresponds to embodiment 1). The electronic circuitry according to claim 5 or 6, wherein the controller is configured to generate the first reference voltage to be used in a turn-off operation or a turn-on operation in a next or subsequent switching cycle, based on the steady-state value of the output voltage sampled after completion of a turn-off operation in a current switching cycle.

Clause 8 (which corresponds to embodiment 1). The electronic circuitry according to any one of claims 1 to 7, wherein the voltage detection circuit includes a voltage divider circuit configured to divide the output voltage, and the controller is configured to compare the first reference voltage with a voltage divided by the voltage divider circuit.

Clause 9 (which corresponds to embodiment 1). The electronic circuitry according to any one of claims 1 to 8, wherein the controller includes a first comparator whose logic output inverts when the output voltage crosses the first reference voltage, and is configured to determine the first current value or the second current value based on the logic output of the first comparator.

Clause 10 (which corresponds to embodiment 3). The electronic circuitry according to any one of claims 1 to 9, wherein the controller is configured to generate the first reference voltage based on information dependent on the power voltage, the information being provided from outside of the electronic circuitry.

Clause 11 (which corresponds to embodiment 2). The electronic circuitry according to any one of claims 1 to 10, wherein the controller is configured to compare the output voltage with a second reference voltage determined in accordance with the power voltage, and determine, based on a comparison result, the first current value, the second current value, or a third current value having an absolute value larger than the absolute value of the second current value and a direction same as a direction of the second current value, and
the current supply circuit is configured to supply the drive current to the switching element based on the first current value, the second current value, or the third current value determined by the controller.

Clause 12 (which corresponds to embodiment 2). the electronic circuitry according to claim 11, wherein the controller is configured to determine the first current value before the output voltage reaches the first reference voltage, determine the second current value after the output voltage reaches the first reference voltage and before the output voltage reaches the second reference voltage, and determine the third current value after the output voltage reaches the second reference voltage.

Clause 13 (which corresponds to embodiment 2). The electronic circuitry according to claim 11 or 12, wherein the controller is configured to generate the second reference voltage based on a steady-state value of the output voltage after completion of the turn-off operation of the switching element.

Clause 14 (which corresponds to embodiment 2). The electronic circuitry according to claim 13, wherein the controller is configured to determine the second reference voltage Ref2 in accordance with the following expression: Ref2=β·Voff where Voff is the steady-state value of the output voltage, and β is a predetermined constant.

Clause 15 (which corresponds to embodiment 2). The electronic circuitry according to any one of claims 11 to 14, wherein the controller includes a second comparator whose logic output inverts when the output voltage crosses the second reference voltage, and is configured to determine the second current value or the third current value based on the logic output of the second comparator.

Clause 16 (which corresponds to embodiment 3). The electronic circuitry

according to any one of claims 11 to 15, wherein the controller is configured to generate the second reference voltage based on information dependent on the power voltage, the information being provided from outside of the electronic circuitry.

Clause 17 (which corresponds to modification of embodiment 2). The electronic circuitry according to any one of claims 1 to 16, wherein the controller is configured to determine a third current value after a second predetermined time has elapsed since the second current value was determined, and wherein the current supply circuit is configured to supply the drive current based on the third current value determined by the controller.

Clause 18. A power converter comprising:
a half-bridge circuit including two switching elements; and
a first drive circuit and a second drive circuit configured to control the two switching elements, respectively, in accordance with a control signal instructing a turn-off operation or a turn-on operation,
wherein each of the first drive circuit and the second drive circuit includes:
a voltage detection circuit configured to detect an output voltage of the switching element controlled by the drive circuit;
a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and
a current supply circuit configured to supply a drive current to the switching element based on the first current value or the second current value determined by the controller.

Clause 19. A power conversion apparatus comprising: three power converters according to claim 18.

Clause 20. A driving method comprising:
detecting an output voltage of a switching element controlled in accordance with a control signal instructing a turn-off operation or a turn-on operation;
comparing, in a transition period of the turn-off operation or the turn-on operation, the output voltage with a first reference voltage determined in accordance with a power voltage, and determining, based on a comparison result, a first current value or a second current value having an absolute value smaller than an absolute value of the first current value and a direction same as a direction of the first current value; and
supplying a drive current to the switching element based on the first current value or the second current value.

1. An electronic circuitry comprising:
a voltage detection circuit configured to detect an output voltage of a switching element controlled in accordance with a control signal instructing a turn-off operation or a turn-on operation;
a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and
a current supply circuit configured to supply a drive current to the switching element based on the first current value or the second current value determined by the controller.

2. The electronic circuitry according to claim 1, wherein the controller is configured to determine the first current value before the output voltage reaches the first reference voltage, and determine the second current value after the output voltage reaches the first reference voltage.

3. The electronic circuitry according to claim 1, wherein the controller is configured to generate the first reference voltage based on a steady-state value of the output voltage after completion of the turn-off operation of the switching element.

4. The electronic circuitry according to claim 3, wherein the controller is configured to determine the first reference voltage Ref1 in accordance with the following expression: Ref1=α·Voff where Voff is the steady-state value of the output voltage, and α is a predetermined constant greater than 0 and less than 1.

5. The electronic circuitry according to claim 3, wherein the controller is configured to sample the steady-state value of the output voltage after completion of the turn-off operation of the switching element, and generate the first reference voltage based on the sampled steady-state value of the output voltage.

6. The electronic circuitry according to claim 5, wherein the controller is configured to sample the steady-state value of the output voltage at a timing when a first predetermined time has elapsed after a logic value of the control signal is inverted.

7. The electronic circuitry according to claim 5, wherein the controller is configured to generate the first reference voltage to be used in a turn-off operation or a turn-on operation in a next or subsequent switching cycle, based on the steady-state value of the output voltage sampled after completion of a turn-off operation in a current switching cycle.

8. The electronic circuitry according to claim 1, wherein the voltage detection circuit includes a voltage divider circuit configured to divide the output voltage, and the controller is configured to compare the first reference voltage with a voltage divided by the voltage divider circuit.

9. The electronic circuitry according to claim 1, wherein the controller includes a first comparator whose logic output inverts when the output voltage crosses the first reference voltage, and is configured to determine the first current value or the second current value based on the logic output of the first comparator.

10. The electronic circuitry according to claim 1, wherein the controller is configured to generate the first reference voltage based on information dependent on the power voltage, the information being provided from outside of the electronic circuitry.

11. The electronic circuitry according to claim 1, wherein the controller is configured to compare the output voltage with a second reference voltage determined in accordance with the power voltage, and determine, based on a comparison result, the first current value, the second current value, or a third current value having an absolute value larger than the absolute value of the second current value and a direction same as a direction of the second current value, and
the current supply circuit is configured to supply the drive current to the switching element based on the first current value, the second current value, or the third current value determined by the controller.

12. The electronic circuitry according to claim 11, wherein the controller is configured to determine the first current value before the output voltage reaches the first reference voltage, determine the second current value after the output voltage reaches the first reference voltage and before the output voltage reaches the second reference voltage, and determine the third current value after the output voltage reaches the second reference voltage.

13. The electronic circuitry according to claim 11, wherein the controller is configured to generate the second reference voltage based on a steady-state value of the output voltage after completion of the turn-off operation of the switching element.

14. The electronic circuitry according to claim 13, wherein the controller is configured to determine the second reference voltage Ref2 in accordance with the following expression: Ref2=β·Voff where Voff is the steady-state value of the output voltage, and β is a predetermined constant.

15. The electronic circuitry according to claim 11, wherein the controller includes a second comparator whose logic output inverts when the output voltage crosses the second reference voltage, and is configured to determine the second current value or the third current value based on the logic output of the second comparator.

16. The electronic circuitry according to claim 11, wherein the controller is configured to generate the second reference voltage based on information dependent on the power voltage, the information being provided from outside of the electronic circuitry.

17. The electronic circuitry according to claim 1, wherein the controller is configured to determine a third current value after a second predetermined time has elapsed since the second current value was determined, and wherein the current supply circuit is configured to supply the drive current based on the third current value determined by the controller.

18. A power converter comprising:
a half-bridge circuit including two switching elements; and
a first drive circuit and a second drive circuit configured to control the two switching elements, respectively, in accordance with a control signal instructing a turn-off operation or a turn-on operation,
wherein each of the first drive circuit and the second drive circuit includes:
a voltage detection circuit configured to detect an output voltage of the switching element controlled by the drive circuit;
a controller configured to compare, in a transition period of the turn-off operation or the turn-on operation, the output voltage with a first reference voltage determined in accordance with a power voltage, and determine, based on a comparison result, a first current value or a second current value having an absolute value smaller than an absolute value of the first current value and a direction same as a direction of the first current value; and
a current supply circuit configured to supply a drive current to the switching element based on the first current value or the second current value determined by the controller.

19. A power conversion apparatus comprising: three power converters according to claim 18.

20. A driving method comprising:
detecting an output voltage of a switching element controlled in accordance with a control signal instructing a turn-off operation or a turn-on operation;
comparing, in a transition period of the turn-off operation or the turn-on operation, the output voltage with a first reference voltage determined in accordance with a power voltage, and determining, based on a comparison result, a first current value or a second current value having an absolute value smaller than an absolute value of the first current value and a direction same as a direction of the first current value; and
supplying a drive current to the switching element based on the first current value or the second current value.
